(19) United States
(12) Patent Application Publication
(10) Pub. No.: US 2015/0302300 A1
(43) Pub. Date: Oct. 22, 2015

(54) EFFICIENT GRAPH-BASED RULE ENGINE FOR COMPLEX, DYNAMIC, UNSTRUCTURED DATA

(71) Applicant: Voalte, Inc., Sarasota, FL (US)

(72) Inventors: Donnie C. Fletcher, Sarasota, FL (US); Trevor J. Brown, Sarasota, FL (US); Joshua J. Burroughs, Sarasota, FL (US)

(73) Assignee: Voalte, Inc., Sarasota, FL (US)

(21) Appl. No.: 14/256,854

(22) Filed: Apr. 18, 2014

(51) Int. Cl. G06N 5/04

(52) U.S. Cl. CPC G06N 5/04

(57) ABSTRACT

Systems and methods can support efficient graph-based rule engines for complex, dynamic, unstructured data. The system can provide an interface to a graph database for storing rules and facts. The system can receive rules and facts. The system can convert the received rules to a format suitable for insertion into the graph database and store the converted rules into the graph database. The system can receive a question and perform a query against the graph database to evaluate rules and facts in light of the received question. The system can return facts retrieved from the graph database in response to the performed query. Also, the system can generate one or more actions based upon facts retrieved or rules trigger in response to the performed query.

### BACKGROUND

Complex datasets, such as those encountered within healthcare enterprises, are often weakly structured or even unstructured. Such datasets often attempt to aggregate frequently changing information from many diverse sources having different structures and formats. Operating rules associated with such data may also be complex and highly dynamic.

There are numerous challenges to implementing intelligent rule engines to handle such complex datasets and their associated production rules. Even traditional graph-based solutions, which provide improvements over brute force rule engine implementations, quickly show their limitations when complex datasets and operating rules are encountered.

There is a need in the art for rule engine technology that can safely and efficiently supports very large, unstructured datasets that may frequently change in real time. Such solutions would be particularly applicable in large, information-driven enterprises such as healthcare facilities or systems thereof.

### SUMMARY

In certain example embodiments described herein, methods and systems can support efficient graph-based rule engines for complex, dynamic, unstructured data. The system can provide an interface to a graph database for storing rules and facts. The system can receive rules and facts. The system can convert the received rules to a format suitable for insertion into the graph database and store the converted rules into the graph database. The system can receive a question and perform a query against the graph database to evaluate rules and facts in light of the received question. The system can return facts retrieved from the graph database in response to the performed query. Also, the system can generate one or more actions based upon facts retrieved or rules trigger in response to the performed query.

These and other aspects, objects, features, and advantages of the example embodiments will become apparent to those having ordinary skill in the art upon consideration of the following detailed description of illustrated example embodiments.

### BRIEF DESCRIPTION OF THE DRAWINGS

FIG. 1 is a block diagram depicting a rule implementation system associated with a graph database in accordance with one or more embodiments presented herein.

FIG. 2 is an example data structure diagram illustrating a rule-fact graph associated with a rule implementation system in accordance with one or more embodiments presented herein.

FIG. 3 is a block flow diagram depicting a method for efficient graph-based rule engines leveraging graph databases in accordance with one or more embodiments presented herein.

FIG. 4 is a block diagram depicting a computing machine and a module in accordance with one or more embodiments presented herein.

### DETAILED DESCRIPTION OF EXAMPLE EMBODIMENTS

### Overview

The methods and systems described herein enable an efficient graph-based rule engine for complex, dynamic, unstructured data. The rule engine can operate directly within, or in conjunction with, a graph database system. The rule engine can leverage native pattern matching capabilities, schema-less structure support, and disk-backed performance of the graph database. This architecture can provide reduced complexity in storage and definition of complex rules and rule sets, automated assertion of facts, and significantly improved efficiency.

The functionality of the various example embodiments will be explained in more detail in the following description, read in conjunction with the figures illustrating the program flow. Turning now to the drawings, in which like numerals indicate like (but not necessarily identical) elements throughout the figures, example embodiments are described in detail.

### Example System Architectures

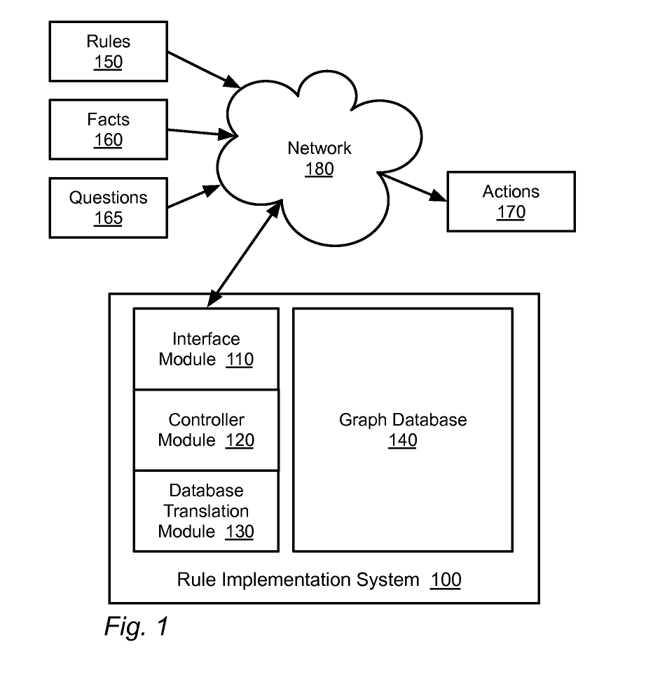

FIG. 1 is a block diagram depicting a rule implementation system 100 associated with a graph database 140 in accordance with one or more embodiments presented herein. The rule implementation system 100 can operate on rules 150 and facts 160 to respond to questions 165 or to establish additional rules 150, additional facts 160, or trigger actions 170. The rule implementation system 100 can include various modules such as an interface module 110, a controller module 120, and a database translation module 130. The rule implementation system 100 can operate directly within, or in conjunction with, a graph database 140. Rules 150, facts 160, questions 165 or actions 170 associated with the rule implementation system 100 may be communicated directly to or from the rule implementation system 100. These communications may also occur in conjunction with one or more networks 180.

The rule implementation system 100 is an example of a rule engine system, production system, or production rule system. These are often used in artificial intelligence, automated planning, expert systems, action selection systems, or other such machine based knowledge or decision systems.

A rule 150 associated with the rule implementation system 100 generally consists of two components: a condition and a result. The condition and result of a rule 150 may be said to have an “if, then” relationship. If the condition obtains, then the rule 150 is triggered causing the result to be fired. The condition generally obtains by the existence, or truth, of one or more facts 160. For example, a condition could be, “if it is Wednesday,” which would trigger when presented with the fact that the day of the week is Wednesday. The result of firing a rule 150 generally involves one or more other facts 160 or the generation of an action 170. Firing of the rule 150 can assert or retract one or more other facts 160. Firing of the rule 150 can also generate one or more actions 170 as output of the rule implementation system 100. Asserting or retracting one or more facts 160 can alter the state of the rule implementation system 100, which may then affect the conditions of other rules 150 causing them to fire. Altering the state of the rule implementation system 100 may also affect the responses provided to questions 165 processed by the rule implementation system 100.

The graph database 140 can provide the working memory of the rule implementation system 100. This working memory can store information comprising the current state or knowledge of the rule implementation system 100. The graph database 140 can store information in a graph structure where nodes are interconnected by edges. The nodes generally represent entities or things such as individuals, departments, or equipment. Edges generally connect nodes representing the relationship between them. Each node may be associated with one or more properties, which may contain information pertinent to that respective node.

The interface module 110 of the rule implementation system 100 can provide an application programming interface (API), scripting interface, domain-specific language (DSL), or other mechanism for interfacing to the rule implementation system 100. The interface module 110 may support transactions with other modules, systems, or entities associated with the rule implementation system 100. These transactions may involve providing rules 150 or facts 160 to the rule implementation system 100, receiving and reacting to questions 165, retrieving rules 150 or facts 160 from the rule implementation system 100, or receiving actions 170 or information associated with actions 170 from the rule implementation system 100.

The controller module 120 of the rule implementation system 100 can process control operations of the rule implementation system 100. Examples of the operations may include executing queries, starting/stopping rule evaluation, and so forth.

The database translation module 130 of the rule implementation system 100 can provide low-level interactions with the graph database 140. These interactions may include performing queries, handling fact node assertion or retraction, database administrative tasks, and so forth.

It should be appreciated that in addition to the interface module 110, controller module 120, database translation module 130, and graph database 140, the rule implementation system 100 may include or interface with other modules. It should also be appreciated that any two or more of these modules may be combined into the same module or modules. Furthermore, any one or more of these modules may split functionally, or load share, between two or more modules or execute on two or more computing machines. Any such modules may operate in a parallel, distributed, or networked fashion without departing from the spirit or scope of the technology presented herein.

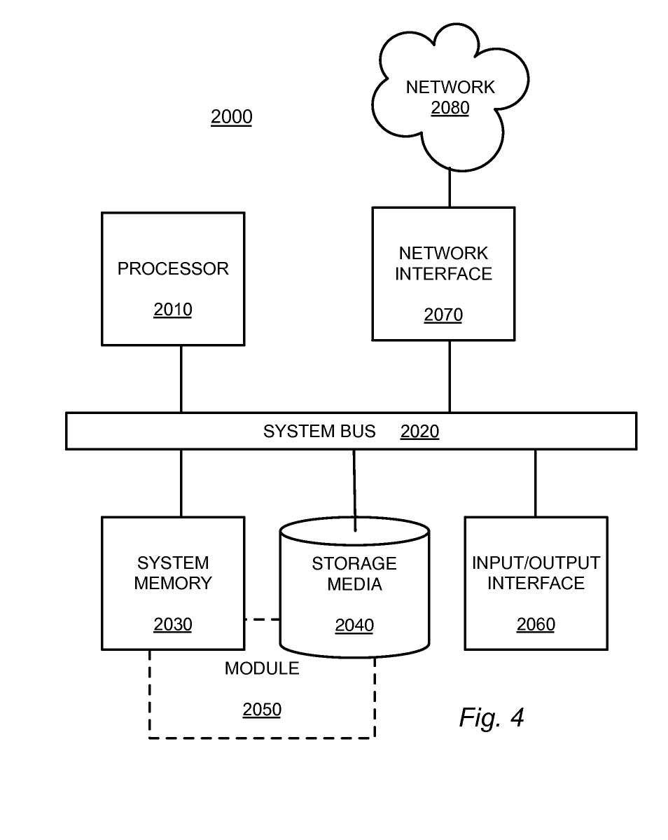

The rule implementation system 100, systems associated with the rules 150, facts 160, or actions 170, or any other systems associated with the technology presented herein may be any type of computing machine such as, but not limited to, those discussed in more detail with respect to FIG. 4. Furthermore, any modules (such as the interface module 110, controller module 120, or database translation module 130) associated with any of these computing machines or any other modules (scripts, web content, software, firmware, or hardware) associated with the technology presented herein may by any of the modules discussed in more detail with respect to FIG. 4. The computing machines discussed herein may communicate with one another as well as other computer machines or communication systems over one or more networks such as network 180. The network 180 may include any type of data or communications network including any of the network technology discussed with respect to FIG. 4.

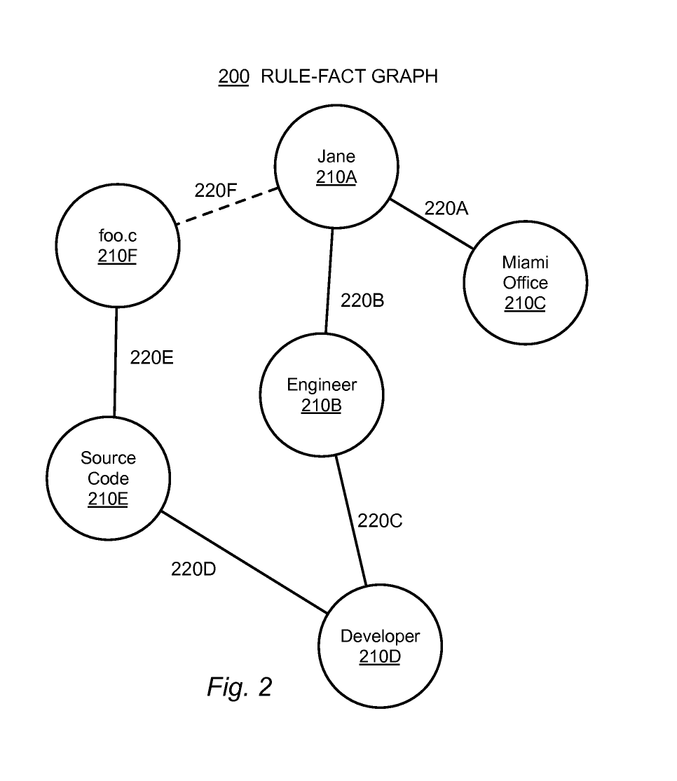

FIG. 2 is an example data structure diagram illustrating a rule-fact graph 200 associated with a rule implementation system 100 in accordance with one or more embodiments presented herein. The illustrated rule-fact graph 200 is a simplified example of a graph that may be stored in the graph database 140 of the rule implementation system 100.

The rule-fact graph 200 includes nodes 210A-210F connected by edges 220A-220F. The nodes 210A-210F may be referred to collectively or in general as nodes 210. Similarly, the edges 220A-220F may be referred to collectively or in general as edges 220.

The rule-fact graph 200 within the graph database 140 can serve as the working memory of the rule implementation system 100. This working memory can store information comprising the current state or knowledge of the rule implementation system 100. This information can include various facts 160, which may be stored as nodes 210 connected by edges 220 representing relationships between the nodes 210 such that the nodes 210 and edges 220 together can encode rules 150.

Rule interpretation may be provided by executing queries on the rule-fact graph 200 within the graph database 140. The queries may be associated with questions 165 posed to the rule implementation system 100. The queries can pattern-match facts 160 against the encoded rules 150 determining which of the rules 150 to apply. The condition portion of each rule 150 may be tested against the current state of the working memory by pattern matching against the rule-fact graph 200. The consequent results can update the knowledge represented by the rule-fact graph 200 by asserting or retracting information. Rule interpretation can execute forward chaining when updated information affects other rules 150 implied within the rule-fact graph 200. The results consequent to the condition can also trigger actions 170. Queries of the rule-fact graph 200 within the graph database 140 can leverage a schema-free storage structure supporting index-free adjacency where any node 210 may be directly linked (by one or more edges 220) to its adjacent nodes 210 such that index lookups are unnecessary.

Considering the illustrated example rule-fact graph 200, node 210A represents the individual named “Jane” and the connection edge 220A between node 210A and the “Miami Office” node 210C can represent that the individual “Jane” works out of the “Miami Office.” The connection edge 220B between node 210A and the “Engineer” node 210B can represent that the individual “Jane” has a role of “Engineer.” The connection edge 220C between node 210B and the “Developer” node 210D can represent that those in the role of “Engineer” are also “Developers.” The connection edge 220D between the “Developer” node 210D and the “Source Code” node 210E can represent a rule 150 that all “Developers” are given access to “Source Code.” The connection edge 220E between the “Source Code” node 210E and the “foo.c” node 210F can represent that source code file “foo.c” is and instance of “Source Code.”

An example rule interpretation can deduce edge 220F between the “foo.c” node 210F and the individual “Jane” node 210A from the rule 150 that all “Developers” are given access to “Source Code” combined with the fact 160 that “Jane” is an “Engineer” and thus a “Developer.” This deduced relationship associated with edge 220F may be the basis for returning “foo.c” as an answer to the question 165 “What source code files does Jane have access to?” The deduced relationship associated with edge 220F may also be the basis for returning “Jane” as an answer to the question 165 “Who has access to the file foo.c?” According to certain embodiments, the deduced relationship associated with edge 220F can persist in the memory of the rule-fact graph 200 until some other rule interpretation or operation on the graph database 140 retracts it.

Representing rules 150 within the graph database 140 provide the ability to establish adjacencies between any nodes 210 (and thus relationships between facts 160) without having to rebuild schemas or introduce associating tags or indices. Accordingly, rules 150 may be changed or introduced anew within the rule-fact graph 200 very efficiently and with reduced effort or overhead. For example in the illustrated rule-fact graph 200, if the rules that all developers have access to source code was changed to all engineers have access to source code, the connection edge 220D between the “Developer” node 210D and the “Source Code” node 210E would simply be moved to connect the “Engineer” node 210B and the “Source Code” node 210E. Changing this rule representation in a traditional database for a huge number of engineers/developers and/or a huge number of source code files could be extremely time consuming and nearly impossible, is such rules changed frequently as they might in certain complex enterprise environments such as health care information systems.

Further considering the example rule-fact graph 200 as illustrated, an example query for individuals adjacent to both the “Engineer” node 210B and the “Miami Office” node 210C can rapidly answer the question 165 of “which individuals in the Miami Office are engineers?”

The rule implementation system 100 and its rule-fact graphs 200 can provide the functionality and benefits of various graph-structured rule implementations, such as the Rete Algorithm, along with additional benefits for handling datasets and rule sets presenting the challenge of being any combination of very large, complex, dynamic, or unstructured.

Some examples of additional benefits to the rule implementation system 100 relate to it being more suitable for managing ad hoc and changing data with evolving schemas. For example, in a healthcare enterprise such as a hospital department, the number of nurses may vary from shift to shift, as might the number of patients. Furthermore, the roles of the nurses may change and the assignments relating the nurses to specific patients may also change. When additional facts 160 and rules 150 associated with the hospital department come into play, the rule-fact graph 200 can quickly become very large even while being dynamic (rapidly changing). For example, the additional facts 160 and rules 150 may relate to procedures, medications, food service, radiology, tests, specialist referrals, admit/discharges, code emergencies, monitoring alarms, and so forth. Other example additional facts 160 and rules 150 may relate to routing messages, alarms, notifications, voice calls, text messages, or other communication modalities to one or more nurses (or wireless mobile devices associated therewith) within a healthcare enterprise. This type of information is also well addressed by the schema-less structure support of the rule implementation system 100 and its associated graph database 140.

Another example benefit to the rule implementation system 100 stems from the native pattern matching capabilities of the rule implementation system 100 and its associated graph database 140. Such native pattern matching support can provide for significant increases in efficiencies related to rule interpretation and associated queries.

Yet another example benefit to the rule implementation system 100 relates to the disk-backed performance of the rule implementation system 100 and its associated graph database 140. Disk-backed operation can provide persistence of state by maintain information within the graph database 140. Disk-backed operation can also overcome working memory limitations encountered in operating on a rule-fact graph 200 of ever increasing size and complexity.

### Example Processes

According to methods and blocks described in the embodiments presented herein, and, in alternative embodiments, certain blocks can be performed in a different order, in parallel with one another, omitted entirely, and/or combined between different example methods, and/or certain additional blocks can be performed, without departing from the scope and spirit of the invention. Accordingly, such alternative embodiments are included in the invention described herein.

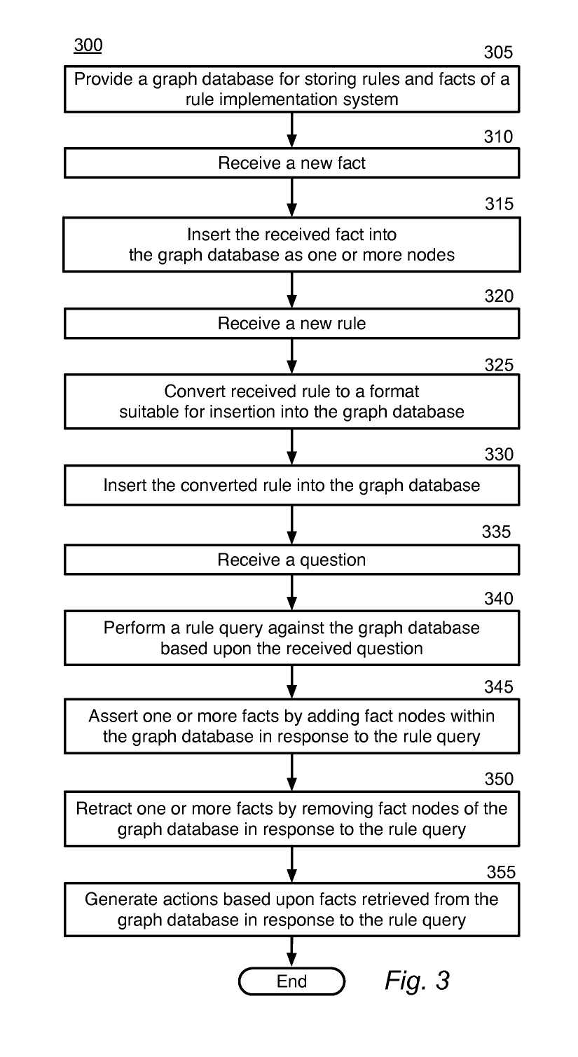

FIG. 3 is a block flow diagram depicting a method 300 for efficient graph-based rule engines leveraging graph databases 140 in accordance with one or more embodiments presented herein. In block 305, the rule implementation system 100 can provide a graph database 140 for storing rules 150 and facts 160 and responding to questions 165. The graph database 140 can provide persistence of the rules 150 and facts 160 associated with the rule implementation system 100.

In block 310, the rule implementation system 100 can receive a new fact 160 via the interface module 110. The interface module 110 can provide an API, scripting interface, DSL, or other mechanism for interfacing to the rule implementation system 100.

In block 315, the database translation module 130 of the rule implementation system 100 can insert the received fact 160 into the graph database 140 as one or more nodes 210

In block 320, the rule implementation system 100 can receive a new rule 150 via the interface module 110. The interface module 110 can provide an API, scripting interface, DSL, or other mechanism for interfacing to the rule implementation system 100.

In block 325, the rule implementation system 100 can convert the received rule 150 to a format suitable for insertion into the graph database 140. For example, the rule 150 may be converted to one or more nodes 210 and one or more edges 220.

In block 330, the database translation module 130 of the rule implementation system 100 can insert the converted rule 150 into the graph database 140. Rules 150 may be inserted by adding one or more nodes 210 to the graph database 140 and then forming one or more edges 220 between newly inserted nodes 210 or existing nodes 210. These edges 220 establish relationship between the nodes 210 which may represent facts 160. For example, the rule “all ravens are black,” might be represented in the graph database 140 by creating nodes 210 for “ravens” and “black” followed by connecting those nodes 210 with an edge 220 having the property or implication of “is” or “are.” Were this same example rule received while nodes 210 for “ravens” and “black” already exist, then the rule may be entered by merely forming the relationship edge 220 between those two nodes.

In block 335, the rule implementation system 100 can receive a question 165. In block 340, the rule implementation system 100 can perform a rule query against the graph database 140 in response to the received question 165. The question 165 may be pattern matched against facts and relationships stored within the nodes 210 and edges 220 of the graph database 140 by issuing a query to the graph database 140. In response to the query, various facts 160 may be reported, facts and/or rules 150 may be asserted or retracted within the graph database 140, or actions 170 may be initiated by the triggering of rules 150. It should be appreciated that these questions 165 and related queries may relate to the operational rules for a healthcare information system such as those associated with voice communications, roles, alarms, and message of various actors such as nurses, technicians, physicians, specialists, or other clinical providers.

In block 345, the rule implementation system 100 can assert one or more facts 160 by adding one or more fact nodes 210 within the graph database 140 in response to the rule query of block 340.

In block 350, the rule implementation system 100 can retract one or more facts 160 by removing one or more fact nodes 210 of the graph database 140 in response to the rule query of block 340.

In block 355, the rule implementation system 100 can generate actions 170 based upon facts 160 retrieved from the graph database 140 in response to the rule query. Facts 160 can be retrieved from the graph database 140 via the interface module 110 or by using a native query language of the graph database 140. Actions 170 may also be based upon rules 150 triggered (or fired) with respect to the graph database 140 in response to the rule query.

### Example Systems

FIG. 4 depicts a computing machine 2000 and a module 2050 in accordance with one or more embodiments presented herein. The computing machine 2000 may correspond to any of the various computers, servers, mobile devices, embedded systems, or computing systems presented herein. The module 2050 may comprise one or more hardware or software elements configured to facilitate the computing machine 2000 in performing the various methods and processing functions presented herein. The computing machine 2000 may include various internal or attached components such as a processor 2010, system bus 2020, system memory 2030, storage media 2040, input/output interface 2060, and a network interface 2070 for communicating with a network 2080.

The computing machine 2000 may be implemented as a conventional computer system, an embedded controller, a laptop, a server, a mobile device, a smartphone, a set-top box, a kiosk, a vehicular information system, one more processors associated with a television, a customized machine, any other hardware platform, or any combination or multiplicity thereof. The computing machine 2000 may be a distributed system configured to function using multiple computing machines interconnected via a data network or bus system.

The processor 2010 may be configured to execute code or instructions to perform the operations and functionality described herein, manage request flow and address mappings, and to perform calculations and generate commands. The processor 2010 may be configured to monitor and control the operation of the components in the computing machine 2000. The processor 2010 may be a general purpose processor, a processor core, a multiprocessor, a reconfigurable processor, a microcontroller, a digital signal processor (“DSP”), an application specific integrated circuit (“ASIC”), a graphics processing unit (“GPU”), a field programmable gate array (“FPGA”), a programmable logic device (“PLD”), a controller, a state machine, gated logic, discrete hardware components, any other processing unit, or any combination or multiplicity thereof. The processor 2010 may be a single processing unit, multiple processing units, a single processing core, multiple processing cores, special purpose processing cores, co-processors, or any combination thereof. According to certain embodiments, the processor 2010 along with other components of the computing machine 2000 may be a virtualized computing machine executing within one or more other computing machines.

The system memory 2030 may include non-volatile memories such as read-only memory (“ROM”), programmable read-only memory (“PROM”), erasable programmable read-only memory (“EPROM”), flash memory, or any other device capable of storing program instructions or data with or without applied power. The system memory 2030 also may include volatile memories, such as random access memory (“RAM”), static random access memory (“SRAM”), dynamic random access memory (“DRAM”), and synchronous dynamic random access memory (“SDRAM”). Other types of RAM also may be used to implement the system memory 2030. The system memory 2030 may be implemented using a single memory module or multiple memory modules. While the system memory 2030 is depicted as being part of the computing machine 2000, one skilled in the art will recognize that the system memory 2030 may be separate from the computing machine 2000 without departing from the scope of the subject technology. It should also be appreciated that the system memory 2030 may include, or operate in conjunction with, a non-volatile storage device such as the storage media 2040.

The storage media 2040 may include a hard disk, a floppy disk, a compact disc read only memory (“CD-ROM”), a digital versatile disc (“DVD”), a Blu-ray disc, a magnetic tape, a flash memory, other non-volatile memory device, a solid sate drive (“SSD”), any magnetic storage device, any optical storage device, any electrical storage device, any semiconductor storage device, any physical-based storage device, any other data storage device, or any combination or multiplicity thereof. The storage media 2040 may store one or more operating systems, application programs and program modules such as module 2050, data, or any other information. The storage media 2040 may be part of, or connected to, the computing machine 2000. The storage media 2040 may also be part of one or more other computing machines that are in communication with the computing machine 2000 such as servers, database servers, cloud storage, network attached storage, and so forth.

The module 2050 may comprise one or more hardware or software elements configured to facilitate the computing machine 2000 with performing the various methods and processing functions presented herein. The module 2050 may include one or more sequences of instructions stored as software or firmware in association with the system memory 2030, the storage media 2040, or both. The storage media 2040 may therefore represent examples of machine or computer readable media on which instructions or code may be stored for execution by the processor 2010. Machine or computer readable media may generally refer to any medium or media used to provide instructions to the processor 2010. Such machine or computer readable media associated with the module 2050 may comprise a computer software product. It should be appreciated that a computer software product comprising the module 2050 may also be associated with one or more processes or methods for delivering the module 2050 to the computing machine 2000 via the network 2080, any signal-bearing medium, or any other communication or delivery technology. The module 2050 may also comprise hardware circuits or information for configuring hardware circuits such as microcode or configuration information for an FPGA or other PLD.

The input/output (“I/O”) interface 2060 may be configured to couple to one or more external devices, to receive data from the one or more external devices, and to send data to the one or more external devices. Such external devices along with the various internal devices may also be known as peripheral devices. The I/O interface 2060 may include both electrical and physical connections for operably coupling the various peripheral devices to the computing machine 2000 or the processor 2010. The I/O interface 2060 may be configured to communicate data, addresses, and control signals between the peripheral devices, the computing machine 2000, or the processor 2010. The I/O interface 2060 may be configured to implement any standard interface, such as small computer system interface (“SCSI”), serial-attached SCSI (“SAS”), fiber channel, peripheral component interconnect (“PCI”), PCI express (PCIe), serial bus, parallel bus, advanced technology attachment (“ATA”), serial ATA (“SATA”), universal serial bus (“USB”), Thunderbolt, FireWire, various video buses, and the like. The I/O interface 2060 may be configured to implement only one interface or bus technology. Alternatively, the I/O interface 2060 may be configured to implement multiple interfaces or bus technologies. The I/O interface 2060 may be configured as part of, all of, or to operate in conjunction with, the system bus 2020. The I/O interface 2060 may include one or more buffers for buffering transmissions between one or more external devices, internal devices, the computing machine 2000, or the processor 2010.

The I/O interface 2060 may couple the computing machine 2000 to various input devices including mice, touch-screens, scanners, biometric readers, electronic digitizers, sensors, receivers, touchpads, trackballs, cameras, microphones, keyboards, any other pointing devices, or any combinations thereof. The I/O interface 2060 may couple the computing machine 2000 to various output devices including video displays, speakers, printers, projectors, tactile feedback devices, automation control, robotic components, actuators, motors, fans, solenoids, valves, pumps, transmitters, signal emitters, lights, and so forth.

The computing machine 2000 may operate in a networked environment using logical connections through the network interface 2070 to one or more other systems or computing machines across the network 2080. The network 2080 may include wide area networks (“WAN”), local area networks (“LAN”), intranets, the Internet, wireless access networks, wired networks, mobile networks, telephone networks, optical networks, or combinations thereof. The network 2080 may be packet switched, circuit switched, of any topology, and may use any communication protocol. Communication links within the network 2080 may involve various digital or an analog communication media such as fiber optic cables, free-space optics, waveguides, electrical conductors, wireless links, antennas, radio-frequency communications, and so forth.

The processor 2010 may be connected to the other elements of the computing machine 2000 or the various peripherals discussed herein through the system bus 2020. It should be appreciated that the system bus 2020 may be within the processor 2010, outside the processor 2010, or both. According to some embodiments, any of the processor 2010, the other elements of the computing machine 2000, or the various peripherals discussed herein may be integrated into a single device such as a system on chip (“SOC”), system on package (“SOP”), or ASIC device.

In situations in which the systems discussed here collect personal information about users, or may make use of personal information, the users may be provided with a opportunity to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

One or more aspects of embodiments may comprise a computer program that embodies the functions described and illustrated herein, wherein the computer program is implemented in a computer system that comprises instructions stored in a machine-readable medium and a processor that executes the instructions. However, it should be apparent that there could be many different ways of implementing embodiments in computer programming, and the invention should not be construed as limited to any one set of computer program instructions. Further, a skilled programmer would be able to write such a computer program to implement an embodiment of the disclosed invention based on the appended flow charts and associated description in the application text. Therefore, disclosure of a particular set of program code instructions is not considered necessary for an adequate understanding of how to make and use the invention. Further, those skilled in the art will appreciate that one or more aspects of the invention described herein may be performed by hardware, software, or a combination thereof, as may be embodied in one or more computing systems. Moreover, any reference to an act being performed by a computer should not be construed as being performed by a single computer as more than one computer may perform the act.

The example embodiments described herein can be used with computer hardware and software that perform the methods and processing functions described previously. The systems, methods, and procedures described herein can be embodied in a programmable computer, computer-executable software, or digital circuitry. The software can be stored on computer-readable media. For example, computer-readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (“FPGA”), etc.

The example systems, methods, and acts described in the embodiments presented previously are illustrative, and, in alternative embodiments, certain acts can be performed in a different order, in parallel with one another, omitted entirely, and/or combined between different example embodiments, and/or certain additional acts can be performed, without departing from the scope and spirit of embodiments of the invention. Accordingly, such alternative embodiments are included in the inventions described herein.

Although specific embodiments have been described above in detail, the description is merely for purposes of illustration. It should be appreciated, therefore, that many aspects described above are not intended as required or essential elements unless explicitly stated otherwise. Modifications of, and equivalent components or acts corresponding to, the disclosed aspects of the example embodiments, in addition to those described above, can be made by a person of ordinary skill in the art, having the benefit of the present disclosure, without departing from the spirit and scope of the invention defined in the following claims, the scope of which is to be accorded the broadest interpretation so as to encompass such modifications and equivalent structures.

What is claimed is:

1. A computer-implemented method for automated rule implementation, comprising:
providing, by an automated rule system, an interface to a graph database for storing rules and facts;
receiving, by the automated rule system, a fact;
storing, by the automated rule system, the received fact into the graph database;
receiving, by the automated rule system, a rule;
converting, by the automated rule system, the received rule to a format suitable for insertion into the graph database;
storing, by the automated rule system, the converted rule into the graph database;
receiving, by the automated rule system, a question;
performing, by the automated rule system, a query against the graph database to evaluate the rule and the fact in response to the received question; and
answering, by the automated rule system, the question with one or more facts retrieved from the graph database in response to the query.

2. The computer-implemented method of claim 1, further comprising the step of generating, by the automated rule system, one or more actions based upon facts retrieved from the graph database in response to the performed query.

3. The computer-implemented method of claim 1, wherein converting the received rule to the format suitable for insertion into the graph database comprises representing the received rule as one or more nodes and one or more edges.

4. The computer-implemented method of claim 1, wherein performing the query against the graph database comprises applying native pattern matching functionality of the graph database.

5. The computer-implemented method of claim 1, wherein the graph database is disk-backed for persistent storage of rules and facts.

6. The computer-implemented method of claim 1, wherein evaluating the rule comprises asserting or retracting one or more facts within the graph database.

7. The computer-implemented method of claim 1, wherein the automated rule system supports storing schema-less data.

8. The computer-implemented method of claim 1, wherein the automated rule system operates in support of a healthcare enterprise.

9. The computer-implemented method of claim 1, wherein the automated rule system supports rules and data associated with assignments between one or more nurses and one or more patients.

10. The computer-implemented method of claim 1, wherein the automated rule system supports rules and data associated with routing messages, alarms, or notifications to one or more nurses within a healthcare enterprise.

11. An automated rule implementation system, comprising:
one or more processing units, and one or more processing modules, wherein the automated rule implementation system is configured by the one or more processing modules to:
provide an interface to a graph database for storing rules and facts;
receive a fact;
store the received fact into the graph database;
receive a rule;
convert the received rule to a format suitable for insertion into the graph database;
store the converted rule into the graph database;
receive a question;
perform a query against the graph database to evaluate stored rules and facts against the received question;
retrieve one or more facts from the graph database in response to the query; and
return the one or more retrieved facts as answers to the received question.

12. The automated rule implementation system of claim 11, wherein converting the received rule to the format suitable for insertion into the graph database comprises representing the received rule as one or more nodes and one or more edges.

13. The automated rule implementation system of claim 11, wherein performing the query against the graph database comprises applying native pattern matching functionality of the graph database.

14. The automated rule implementation system of claim 11, wherein the graph database is disk-backed to overcome limitations in working memory.

15. The automated rule implementation system of claim 11, wherein the graph database supports storing schema-less data.

16. The automated rule implementation system of claim 11, wherein the graph database operates in support of a healthcare enterprise.

17. The automated rule implementation system of claim 11, wherein the graph database supports rules and data associated with assignments between one or more nurses and one or more patients.

18. The automated rule implementation system of claim 11, wherein the graph database supports storing rules and data associated with routing messages and notifications to one or more wireless mobile devices within a healthcare enterprise.

19. The automated rule implementation system of claim 11, wherein the graph database supports storing rules and data associated with routing messages, alarms, or notifications to one or more nurses within a healthcare enterprise.

20. A computer program product, comprising:
a non-transitory computer-readable storage medium having computer-readable program code embodied therein that, when executed by one or more computing devices, perform a method comprising:
providing an interface to a graph database for storing rules and facts associated with a healthcare;
receiving a fact;
storing the received fact into the graph database;
receiving a rule;
converting the received rule to a format suitable for insertion into the graph database by representing the received rule as one or more nodes and one or more edges;
storing the converted rule into the graph database;
receiving a question;
performing a query against the graph database to evaluate stored rules and facts against the received question;
retrieving one or more facts from the graph database in response to the query; and
returning the one or more retrieved facts as answers to the received question.
